(19) United States
(12) Patent Application Publication
(10) Pub. No.: US 2019/0232209 A1
(43) Pub. Date: Aug. 1, 2019

(54) DUST FILTER BARREL

(71) Applicant: CHANG TJER MACHINERY CO., LTD., Taichung (TW)

(72) Inventor: Chih-Ching LIN, TAICHUNG (TW)

(21) Appl. No.: 16/383,110

(22) Filed: Apr. 12, 2019

Related U.S. Application Data
(63) Continuation-in-part of application No. 15/612,410, filed on Jun. 2, 2017.
Application No. 15/612,410 is a continuation-in-part of application No. 14/733,374, filed on Jun. 8, 2015, now abandoned.

(30) Foreign Application Priority Data
Aug. 1, 2014 (TW) 103213737

(51) Int. Cl. B01D 46/00; B01D 46/24; B01D 46/52

(52) U.S. Cl. CPC B01D 46/0075; B01D 46/521; B01D 46/2411

(57) ABSTRACT

A dust filter barrel includes a sheet filter cylinder, a mesh cylinder and a fixation base. The sheet filter cylinder has two end faces, an inner layer and an outer layer laminated on the inner layer; wherein the inner layer has a plurality of pores having a first pore diameter, the outer layer has a plurality of pores having a second pore diameter, and the second pore diameter is smaller than the first pore diameter. The mesh cylinder is non-contact with the outer layer of the sheet filter cylinder and sleeved outside the sheet filter cylinder and has two end faces. The fixation base has a first and second cover bodies disposed on the two end faces of the sheet filter cylinder and the mesh cylinder respectively, and the second cover body is formed with at least one opening communicated with the sheet filter cylinder.

### BACKGROUND OF THE INVENTION

### FIELD OF THE INVENTION

This application is a Continuation-in-Part of application Ser. No. 15/612410, filed on Jun. 2, 2017, which is a Continuation-in-Part of application Ser. No.

14/733374, filed on Jun. 8, 2015, for which priority is claimed under 35 U.S.C. § 120; and this application claims priority of Application No. 103213737 filed in Taiwan on Aug. 1, 2014 under 35 U.S.C. § 119, the entire contents of all of which are hereby incorporated by reference.

### DESCRIPTION OF THE PRIOR ART

Usually, a conventional filter device transports air or liquid to be filtered into the filter device, and impurities in the air or liquid to be filtered are filtered by a sheet filter cylinder around the filter device. Some filter devices are further formed with an outermost mesh cylinder to restrain a shape of the sheet filter cylinder. However, the convention filter device as disclosed in TWM305049 filters the air or liquid to be filtered only through a single pore diameter of the sheet filter cylinder; therefore, a filtering effect is not good, and a service life of the sheet filter cylinder is shorter. Furthermore, a position where the sheet filter cylinder and the mesh cylinder contact with each other constantly is easily abraded.

U.S. Pat. No. 5,427,597 discloses that separation of pleats is provided by dimples on both tips on overall regions of the sheet filter cylinder, and the dimples are not disposed only at top and bottom end of the sheet filter cylinder, so that the structure is complicated. Besides, the dimples do not fill up inner and outer spaces between the pleated portions, the sheet filter cylinder is not stable; the potting material is not flexible and is hard so that it has poor shake-absorbing and impact-buffering effects.

U.S. Pat. No. 5,641,343 discloses that the support is a solid seal member (elastic washer or spacer) which cannot flow, before solidification, to fill up inner and outer spaces between the plurality of pleated portions, that filter support provides a small space between filter outer layer and side wall, and it is clearly shown in FIG. 3 that the bottom face is partially exposed since the support does entirely cove the bottom face; that is, the support does not contact the inner face of the notch of second cover body. As a result, the sheet filter cylinder is not firmly held and might shift to contact the mesh cylinder.

U.S. Pat. No. 5,427,597 discloses that the potting material is only capped on the pleated sheet filter, which cannot firmly hold the pleated sheet filter since the pleats of the pleated sheet filter can deform easily.

US2009/0229230 discloses that none of binder fills up the cover body in which the pleated sheet filter is received, which cannot firmly hold the pleated sheet filter since the pleats of the pleated sheet filter can deform easily and so that the pleated sheet filter can displace easily.

The present invention has arisen to mitigate and/or obviate the afore-described disadvantages.

### SUMMARY OF THE INVENTION

The major object of the present invention is to provide a dust filter barrel which has multiple pore diameters and can prevent a sheet filter cylinder and the mesh cylinder from being broken due to abrasion with each other.

To achieve the above and other objects, a dust filter barrel is provided, including a sheet filter barrel, a mesh cylinder and a fixation base. The sheet filter cylinder has an upper end face and a lower end face and has an inner layer and an outer layer which is laminated on the inner layer; wherein, the inner layer has a plurality of pores having a first pore diameter, the outer layer has a plurality of pores having a second pore diameter, and the second pore diameter is smaller than the first pore diameter. The mesh cylinder is non-contact with the outer layer of the sheet filter cylinder and sleeved outside the sheet filter cylinder, and the mesh cylinder has an upper end face and a lower end face. The fixation base has a first cover body covering the upper end faces of the sheet filter cylinder and the mesh cylinder and a second cover body covering the lower end faces of the sheet filter cylinder and the mesh cylinder, and the second cover body is formed with at least one opening which is communicated with an interior of the sheet filter cylinder.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing of a dust filter barrel of a preferred embodiment of the present invention;

FIG. 2 is a partial breakdown drawing of the dust filter barrel of the preferred embodiment of the present invention;

FIG. 3 is a breakdown drawing of the dust filter barrel of the preferred embodiment of the present invention;

FIG. 4 is a cross-sectional drawing of the dust filter barrel of the preferred embodiment of the present invention;

FIG. 5 is a partial enlarged drawing of a sheet filter of the dust filter barrel of the preferred embodiment of the present invention;

FIG. 6 is another drawing of the dust filter barrel of the preferred embodiment of the present invention;

FIG. 7 is a partial enlarged cross-sectional drawing, taken along the line A-A, of the dust filter barrel of the preferred embodiment of the present invention; and

FIG. 8 is a partial enlarged drawing of FIG. 7.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

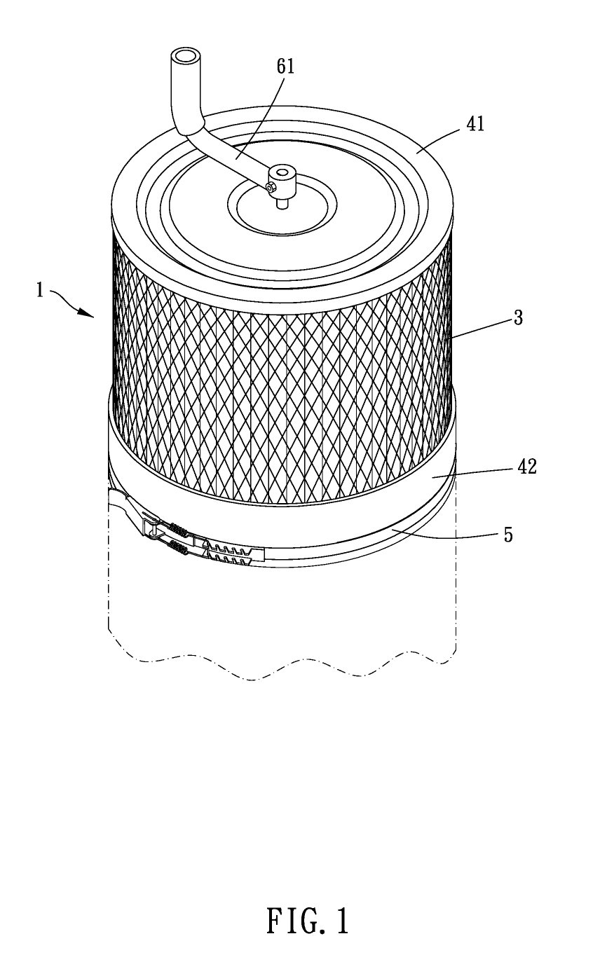

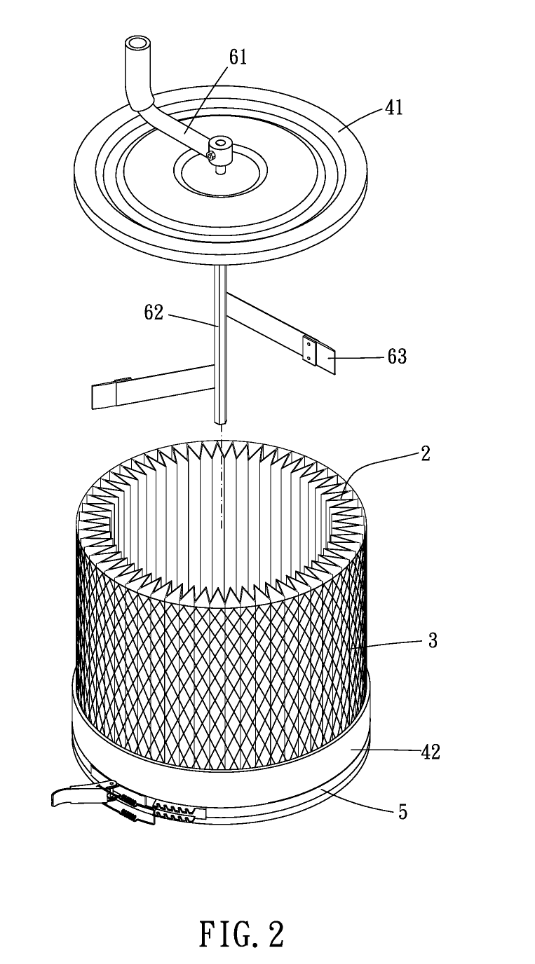

Please refer to FIGS. 1 to 6 for a preferred embodiment of the present invention. The dust filter barrel 1 includes a sheet filter cylinder 2, a mesh cylinder 3 and a fixation base 4.

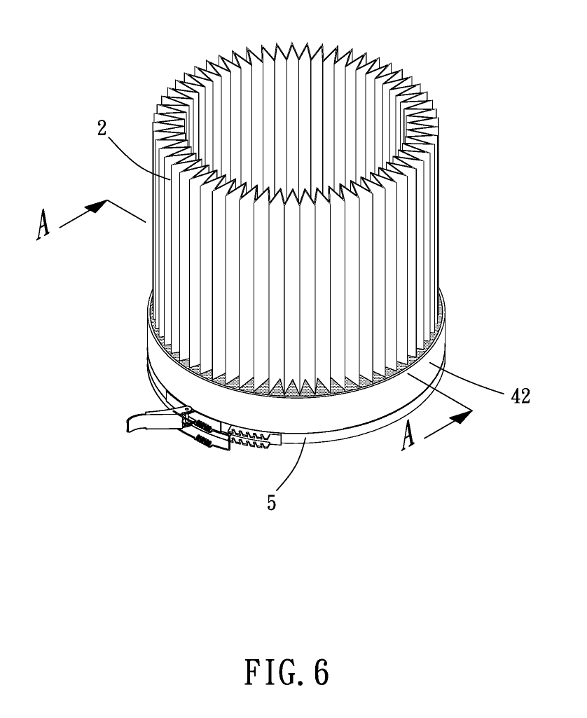

The sheet filter cylinder 2 has an upper end face and a lower end face and has an inner layer 21 and an outer layer 22 which is laminated on the inner layer 21. The sheet filter cylinder 2 may be a paper filter cylinder. The inner layer 21 has a plurality of pores having a first pore diameter, and the outer layer 22 has a plurality of pores having a second pore diameter. The second pore diameter is smaller than the first pore diameter. The sheet filter cylinder 2 has two different pore diameters to achieve multi-filtering. Larger particles are filtered out through the inner layer 21 of the sheet filter cylinder 2, and the second pore diameter is smaller than the first pore diameter; therefore, the outer layer 22 of the sheet filter cylinder 2 filters air flowing therethrough again to decrease a number of particles in the air. Wherein, the outer layer 22 is thinner than the inner layer 21 (as shown in FIG. 5). In this embodiment, a thickness of the outer layer 22 is substantially half of a thickness of the inner layer 21, and the outer layer 22 is laminated directly on a surface of the inner layer 21 to save space.

It is to be noted that the filtering effect depends on a size of the particles filtered out; that is, the filtering effect depends on a size of the first and second pore diameters. As technology advances, air pollution becomes more serious, and suspended matter is viewed as one of the indexes of air quality standards. The Environmental Protection Administration Executive Yuan of Taiwan defines particles under 10 μm as particulate matters. The particulate matters are tiny, and when the particulate matters are inhaled into human bodies, the particulate matters may cause harm to the respiratory tract or other organs. Generally speaking, particles larger than 10 μm can be filtered out through nasal cavity, but particles smaller than 2.5 μm can be inhaled and enter human bodies through the trachea, the bronchus and the pulmonary alveolus and cause bronchitis or bronchial fibrosis. What's more, if there are toxic substances attached on the particles smaller than 2.5 μm, the particles would cause serious harms to different organs in human bodies.

To achieve preferable filtering efficiency and effect, the sheet filter cylinder 2 has a plurality of pleated portions 23 circumferentially arranged. With the pleated 23, a contact area with air is largely increased to elevate the filtering efficiency.

The inner layer 21 of the sheet filter cylinder 2 is made of a plurality of fibers, and the fibers may be chemical fibers or glass fibers. A diameter of each said fiber is 0.5 μm to 2.0 μm, so the fibers can be interwoven with each other to form the inner layer 21 having a plurality of pores having the first pore diameter. Then, a surface of the inner layer 21 can be coated or sprayed with a film to form the outer layer 22. Therefore, the outer layer 22 has the second pore diameter which is smaller than the first pore diameter, wherein a nominal pore size of the second pores is smaller than 0.5 μm. Preferably, the nominal pore size of the second pores is 0.1 μm to 0.5 μm. When the sheet filter cylinder 2 is used, the larger particles, for example, sawdust, pollen or dust are filtered out through the first pore diameter; and then, the smaller particles, for example, wood dust or other industrial dust produced during a processing procedure, are filtered out by the second pore diameter; therefore, the air vented out from the dust filter barrel barely contains particulate matters. Furthermore, through the multi-filtering method, the larger particles are filtered out first, and a service life of the outer layer 22 can be prolonged. Preferably, the second pore diameter of the outer layer 22 is smaller than 0.3 μm and can filter out 99.97% of air particles whose diameter are larger than 0.3 μm to reach the standard of High-Efficiency Particulate Air (HEPA).

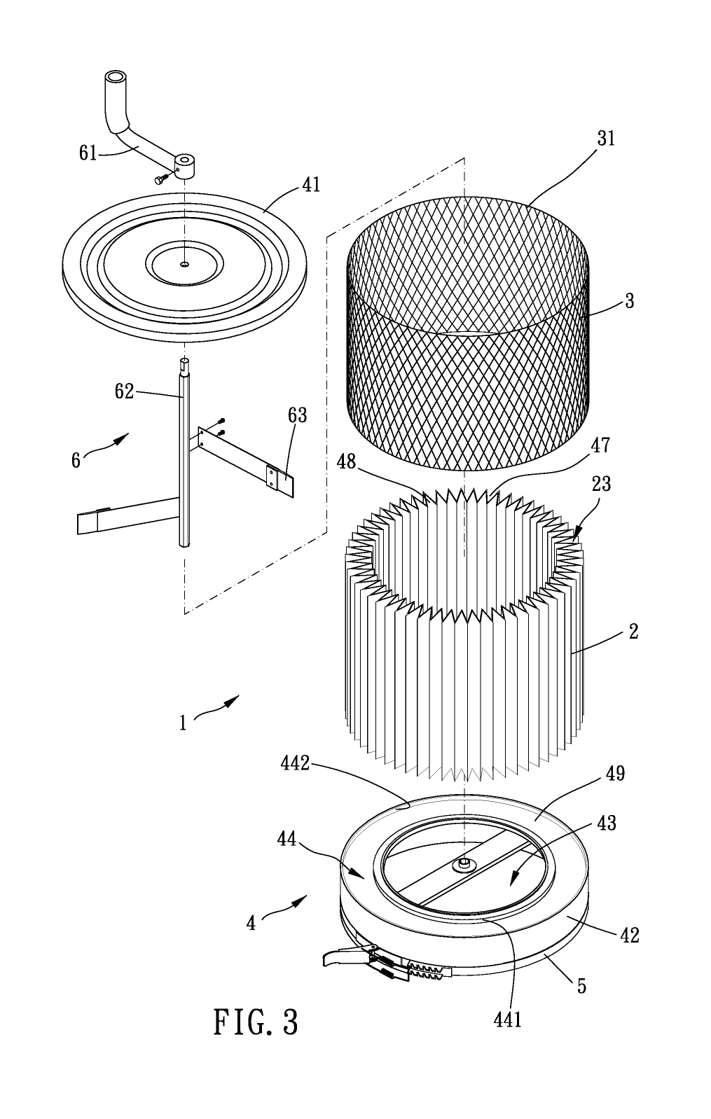

Please further refer to FIGS. 3, 4 and 6. The mesh cylinder 3 is non-contact with the outer layer 22 of the sheet filter cylinder 2 and sleeved outside the sheet filter cylinder 2 and has an upper end face and a lower end face to protect the sheet filter cylinder 2 from losing filtering effect due to unexpected damages. The mesh cylinder 3 and the outer layer 22 of the sheet filter cylinder 2 are non-contact with and separate slightly from each other to prevent the mesh cylinder 3 and the outer layer 22 of the sheet filter cylinder 2 from being broken due to abrasion with each other.

Specifically, the fixation base 4 has a first cover body 41 and a second cover body 42. The first cover body 41 is disposed on the upper end faces of the sheet filter cylinder 2 and the mesh cylinder 3, and the second cover body 42 is disposed on the lower end faces of the sheet filter cylinder 2 and the mesh cylinder 3. The second cover body 42 is formed with at least one opening 43 which is communicated with an interior of the sheet filter cylinder 2. The fixation base 4 at least encapsulates a part of one of the upper and lower faces of the sheet filter cylinder 2, and the mesh cylinder 3 is fixed outside the sheet filter cylinder 2 by the fixation base 4. In this embodiment, the second cover body 42 is formed with two said openings 43 which are substantially semi-circle and symmetrical to each other. Preferably, the fixation base 4 is stuck with the sheet filter cylinder 2 and the mesh cylinder 3. Specifically, the first and second cover bodies 41, 42 are respectively formed with a notch 44 with a binder disposed therein, and the upper end faces and the lower end faces of both the sheet filter cylinder 2 and the mesh cylinder 3 are stuck in each said notch 44 by the binder respectively. Each said notch 44 has a first annular side wall 441 having a relatively smaller radius and a second annular side wall 442 having a relatively larger radius, and the upper and lower end faces of the mesh cylinder 3 tightly engage with each said second annular side wall 442 laterally respectively. The upper and lower end faces of the sheet filter cylinder 2 are arranged between each said first annular side wall 441 and each said second annular side wall 442 respectively and are non-contact with each said first annular side wall 441 and each said second annular side wall 442. In a radial direction of each said notch 44, the upper and lower end faces of the sheet filter cylinder 2 are of 80% to 90% of a radial dimension of each said notch 44 respectively. Hence, the sheet filter cylinder 2 can keep a fixed distance from the mesh cylinder 3 to prevent the sheet filter cylinder 2 from colliding and abrading with the mesh cylinder 3.

Preferably, an outer periphery of the second cover body 42 is further provided with a fastening strip 5. The fastening strip 5 fastens the second cover body 42 to a connection channel which is communicated with the interior of the sheet filter cylinder 2 so as to seal a gap between the connection channel and the outer periphery of the second cover body 42 and prevent the particulate matters filtered from leaking out. In addition, it is convenient for a user to assemble or disassemble the fastening strip 5. Furthermore, when the sheet filter cylinder 2 is cleaned, the dust or particles in the sheet filter cylinder 2 fall directly from the opening 43 of the second cover body 42 through the connection channel into an additional collection bag. Therefore, it is convenient for the user to clean the sheet filter cylinder 2 and throw away the collection bag.

The upper end faces and the lower end faces of both the sheet filter cylinder 2 and the mesh cylinder 3 are fixedly embedded into the binders 45 in said notches 44 respectively, and the mesh cylinder 3 and the outer layer 22 of the sheet filter cylinder 2 are radially annularly spaced apart from each other by a part of the binder 45 therebetween. The sheet filter cylinder 2 has a plurality of pleated portions 23 circumferentially arranged, the binder 45 is annularly continuously attached radially to an inner face 46 of the notch 44 of second cover body 42 and an entire surface of the outer layer 22 of the sheet filter cylinder 2 within the notch 44 of second cover body 42, and the binder 45 further fills up outer spaces 47 between respective two of the plurality of pleated portions 23. The binder 45 is annularly continuously adhered radially to the inner face 46 of the notch 44 of the second cover body 42 and an entire surface of the inner layer 21 of the sheet filter cylinder 2 within the notch 44 of second cover body 42, and the binder 45 further fills up inner spaces 48 between respective two of the plurality of pleated portions 23. The binder 45 is preferably a flexible material which can absorb shake well and lower the impact when operating or cleaning. The binder 45 may be selected from the group consisting of an epoxy, rubber and elastomeric member. Preferably, the binder 45 further fills up inner spaces 48 between the plurality of pleated portions 23, thus improving shake-absorbing and impact-buffering effects. Preferably, the binder 45 is further disposed through part of grids 31 of the mesh cylinder 3 and binds the part of grids 31 of the mesh cylinder 3, thus improving assembling of parts.

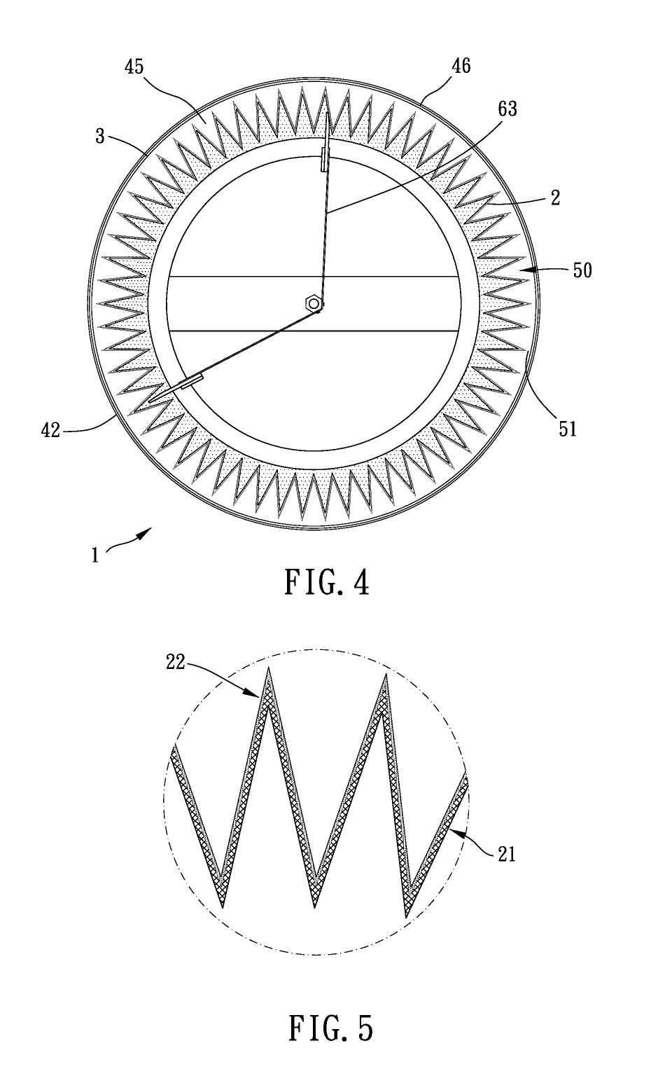

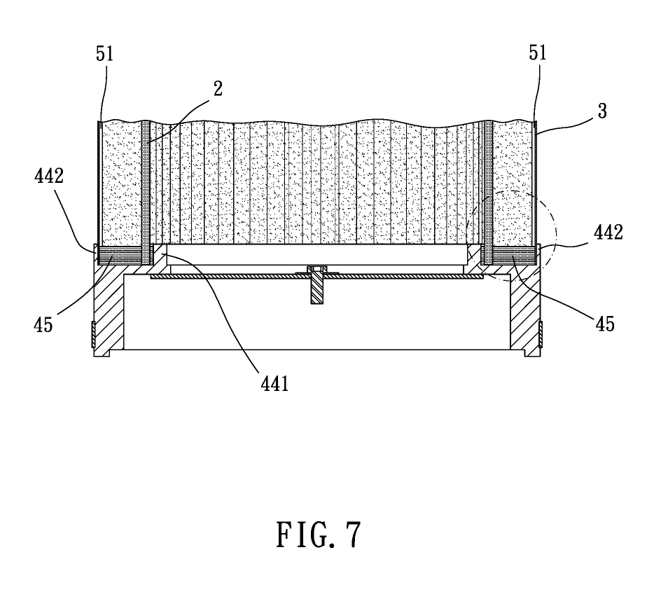

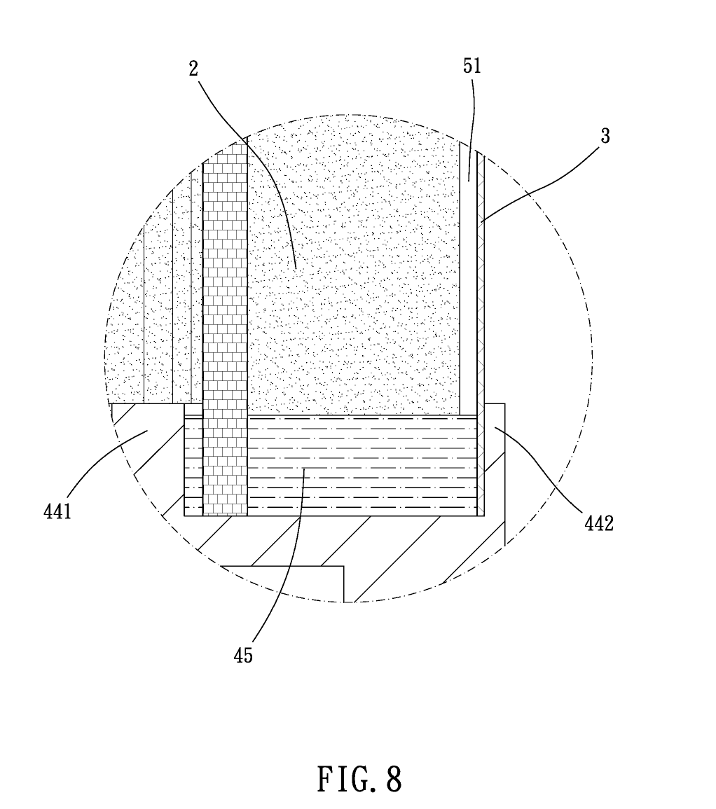

Each said notch 44 has a first annular side wall 441 having a relatively smaller radius and a second annular side wall 442 having a relatively larger radius, the first annular side wall 441 and the second annular side wall 442 is protrusive beyond the binder 45 (FIG. 3), and the first annular side wall 441, the second annular side wall 442 and a top face of the binder 45 form an annular groove 49 (FIG. 3). The sheet filter cylinder, the mesh cylinder and the binder 45 form an entirely solid annular part 50 which is received in the notch 44 (FIG. 4). A part of the binder 45 between the first annular side wall 441 and the inner layer 21 of the sheet filter cylinder 2 and a part of the binder 45 between the second annular side wall 442 and the outer layer 22 of the sheet filter cylinder 2 have the same thickness (as shown in FIGS. 7 and 8). An inner face of the mesh cylinder 3 and the outer layer 22 of the sheet filter cylinder 2 are distanced with a fixed spacing no less than 1 mm (preferably equal to or larger than 2 mm) and have an annular air gap 51 therebetween.

Preferably, the dust filter barrel 1 may further include a whisking assembly 6. The whisking assembly 6 has a handle 61, a pivoted rod 62 and at least one whisking blade 63, wherein an end of the pivoted rod 62 is disposed through the first cover body 41 and connected with the handle 61, the other end is pivoted to the second cover body 42, the at least one whisking blade 63 is fixed on the pivoted rod 62, and the at least one whisking blade 63 contacts an inner wall of the sheet filter cylinder 2. In this embodiment, as viewed from a direction substantially perpendicular to the fixation base 4, a depth of each said whisking blade 63 protruding into one said pleated portion 23 is substantially half of a depth of each said pleated portion 23. When the handle 61 is rotated, the handle 61 actuates the pivoted rod 62 and the whisking blades 63 to rotate. The whisking blades 63 hit the sheet filter cylinder 2 continuously to make the particles on the inner layer 21 of the sheet filter cylinder 2 fall off, and the particles on the outer layer 22 of the sheet filter cylinder 2 can be cleaned through jetting air. In addition, the dust and particles may be cleaned through a pressure difference between an interior and exterior air pressures of the dust filter barrel 1 which can produce air shockwaves to shake off the particles on the sheet filter cylinder 2.

Given the above, the sheet filter cylinder of the dust filter barrel has an inner layer and an outer layer which is laminated on the inner layer, wherein the outer layer is formed by coating or spraying a film on the surface of the inner layer; therefore, the outer layer has the smaller pore diameter than the inner layer does to filter out more particles. The sheet filter cylinder can achieve multi-filtering without additional sheet filter cylinders in different dimensions.

In addition, the sheet filter cylinder is non-contact with the mesh cylinder; therefore, the sheet filter cylinder can be prevented from being broken due to abrasion with the mesh cylinder and losing the filtering effect.

While we have shown and described various embodiments in accordance with the present invention, it should be clear to those skilled in the art that further embodiments may be made without departing from the scope of the present invention.

What is claimed is:

1. A dust filter barrel, including:
a sheet filter cylinder, having an upper end face and a lower end face, having an inner layer and an outer layer laminated on the inner layer, the inner layer having a plurality of pores having a first pore diameter, the outer layer having a plurality of pores having a second pore diameter, the second pore diameter being smaller than the first pore diameter;
a mesh cylinder, being non-contact with the outer layer of the sheet filter cylinder and sleeved outside the sheet filter cylinder, having an upper end face and a lower end face;
a fixation base, having a first cover body covering the upper end faces of the sheet filter cylinder and the mesh cylinder and a second cover body covering the lower end faces of the sheet filter cylinder and the mesh cylinder, the second cover body formed with at least one opening which is communicated with an interior of the sheet filter cylinder;
wherein the first and second cover bodies are respectively formed with a notch filled with a binder, the upper end faces and the lower end faces of both the sheet filter cylinder and the mesh cylinder are fixedly embedded into the binders in said notches respectively, and the mesh cylinder and the outer layer of the sheet filter cylinder are radially annularly spaced apart from each other by a part of the binder therebetween;
wherein the sheet filter cylinder has a plurality of pleated portions circumferentially arranged, the binder is annularly continuously adhered radially to an inner face of the notch of second cover body and an entire surface of the outer layer of the sheet filter cylinder within the notch of second cover body, and the binder further fills up outer spaces between respective two of the plurality of pleated portions;
wherein the binder is annularly continuously adhered radially to the inner face of the notch of second cover body and an entire surface of the inner layer of the sheet filter cylinder within the notch of second cover body, and the binder further fills up inner spaces between respective two of the plurality of pleated portions;
wherein each said notch has a first annular side wall having a relatively smaller radius and a second annular side wall having a relatively larger radius, the first annular side wall and the second annular side wall is protrusive beyond the binder, and the first annular side wall, the second annular side wall and a top face of the binder form an annular groove;
wherein the sheet filter cylinder, the mesh cylinder and the binder form an entirely solid annular part which is received in the notch;
wherein a part of the binder between the first annular side wall and the inner layer of the sheet filter cylinder and a part of the binder between the second annular side wall and the outer layer of the sheet filter cylinder have the same thickness;
wherein an inner face of the mesh cylinder and the outer layer of the sheet filter cylinder are distanced with a fixed spacing no less than 1 mm and have an annular air gap therebetween.

2. The dust filter barrel of claim 1, wherein a nominal pore size of the second pores is 0.1 μm to 0.5 μm.

3. The dust filter barrel of claim 1, wherein the inner layer of the sheet filter cylinder is made of a plurality of fibers, and a diameter of each said fiber is 0.5 μm to 2.0 μm.

4. The dust filter barrel of claim 1, wherein the binder is a flexible material.

5. The dust filter barrel of claim 4, wherein the binder is selected from the group consisting of an epoxy, rubber and elastomeric member.

6. The dust filter barrel of claim 1, wherein the outer layer is thinner than the inner layer.

7. The dust filter barrel of claim 1, wherein the fixation base is stuck with the sheet filter cylinder and the mesh cylinder, the upper and lower end faces of the mesh cylinder tightly engage with each said second annular side wall laterally respectively, the upper and lower end faces of the sheet filter cylinder are arranged between each said first annular side wall and each said second annular side wall respectively and are non-contact with each said first annular side wall and each said second annular side wall; in a radial direction of each said notch, the upper and lower end faces of the sheet filter cylinder are of 80% to 90% of a radial dimension of each said notch respectively.

8. The dust filter barrel of claim 7, wherein the inner layer of the sheet filter cylinder and respective one of the first annular side walls are radially annularly spaced apart from each other by a part of the binder therebetween.

9. The dust filter barrel of claim 1, wherein an outer periphery of the second cover body is further provided with a fastening strip, and the fastening strip fastens the second cover body to a connection channel which is communicated with the interior of the sheet filter cylinder.

10. The dust filter barrel of claim 1, further including a whisking assembly, the whisking assembly having a handle, a pivoted rod and at least one whisking blade, wherein an end of the pivoted rod is disposed through the first cover body and connected with the handle, the other end is pivoted to the second cover body, the at least one whisking blade is fixed on the pivoted rod, the at least one whisking blade contacts an inner wall of the sheet filter cylinder.

11. The dust filter barrel of claim 10, wherein a depth of each said whisking blade protrudes into one said pleated portions a distance ofsubstantially half of a depth of each said pleated portion.

12. The dust filter barrel of claim 10, wherein the binder further fills up inner spaces between the plurality of pleated portions.

13. The dust filter barrel of claim 1, wherein the whisking assembly includes a plurality of said whisking blade, and when one of the plurality of said whisking blade contacts the inner wall of the sheet filter cylinder, at least one of the plurality of said whisking blade is free of contact with the inner wall of the sheet filter cylinder.
